(19) United States
(12) Patent Application Publication
(10) Pub. No.: US 2022/0241789 A1
(43) Pub. Date: Aug. 4, 2022

(54) CONTAINER WITH DRIED REAGENT COMPOSITION AND METHODS FOR USING THE SAME

(71) Applicant: Becton, Dickinson and Company, Franklin Lakes, NJ (US)

(72) Inventors: Jamie Carroll, Tipperary (IE); Barry Emerson, Limerick (IE); Niall O'Keeffe, Askeaton (IE); Adrian Lynch, Limerick (IE)

(21) Appl. No.: 17/580,130

(22) Filed: Jan. 20, 2022

Related U.S. Application Data
(60) Provisional application No. 63/144,185, filed on Feb. 1, 2021.

(51) Int. Cl. B01L 3/00

(52) U.S. Cl. CPC B01L 3/527; B01L 2200/16; B01L 2300/0832

(57) ABSTRACT

Containers including one or more dried reagent compositions are provided. Aspects a subject container may include a container bottom portion defining a first volume and comprising a first dried reagent composition positioned on an inner surface thereof, and a container wall portion attached to the container bottom portion at a sealed attachment region joining the container bottom portion to the container wall portion. Also provided are methods of making and using the container as well as kits including the same.

### CROSS-REFERENCE TO RELATED APPLICATION

Pursuant to 35 U.S.C. § 119 (e), this application claims priority to the filing date of U.S. Provisional Patent Application Ser. No. 63/144,185 filed Feb. 1, 2021; the disclosure of which application is incorporated herein by reference in their entirety.

### INTRODUCTION

Assays for determining the presence and concentration of analytes in a biological sample fluid often rely on the specific binding of a detectable label to the target analyte. The detectable label may be a marker that can be visualized either by an unaided eye or detectable by spectroscopy, such as fluorescence or UV-vis spectroscopy. Typically, fluorescent dyes may be used as the detectable label, where the fluorescent dye includes a particular fluorochrome. A fluorochrome may have a certain properties, such as its absorption spectrum, its extinction coefficient at a wavelength convenient for excitation, its emission spectrum, and its quantum efficiency. Quantum efficiency is the number of photons emitted for every photon absorbed.

Multiplexed assays allow simultaneous detection of multiple analytes in a single assay. For immunoassays, multiplexed assays involve a cocktail of antibodies, each labeled with a different dye. Each antibody binds to a specific analyte or antigen in the sample. In this way, the different analytes or antigens can be differentiated and quantitated based on the different dyes.

For convenience, multiplex assay reagents can be supplied as a premixed cocktail of individual binding molecules, such as antibodies. Other reaction components may be included in the cocktail, such as buffer, salt, surfactant, etc. Most convenient is a cocktail containing all necessary components (a unitary assay reagent). In this case, the assay can be performed by simply adding sample to a reaction vessel containing the cocktail.

It is convenient to provide a stable assay reagent, particularly a reagent that is stable at room temperature. This allows shipment and storage of the reagent without refrigeration. This is especially important for assays performed in rural areas where resources, including electricity, may be limited. To this end, stable reagents may be provided by drying down aqueous solutions of the reagent, or by lyophilization. But a problem exists with some labeled reagents. These reagents become cross-linked if they physically touch one another. They remain cross-linked after resuspension in liquid solution, so that the labels are no longer associated with individual antibodies, causing erroneous results. This can be especially problematic, for example, in the field of flow cytometry, in which a plurality of polymeric dyes are used to create multiple, e.g., 10 or more, fluorescent channels by using only one wavelength for excitation. The chemical nature of these polymeric dyes, however, prevents the storage of multiple dyes in a pooled cocktail. It has been observed that the polymeric entities bind with each other in solution. This results in either erroneous or anomalous cell populations that cannot exist in reality.

### SUMMARY

Containers including one or more dried reagent compositions are provided. Aspects of a subject containers may include a container bottom portion defining a first volume and comprising a first dried reagent composition positioned on an inner surface thereof, and a container wall portion attached to the container bottom portion at a sealed attachment region joining the container bottom portion to the container wall portion. Also provided are methods of making and using the containers, as well as kits including the same.

### BRIEF DESCRIPTION OF THE FIGURES

FIG. 1 provides an exemplary model of two parts of a FACS tube that may be combined to form a liquid tight round bodied FACS tube containing a dried high parameter flow cytometry panel in accordance with an embodiment of the invention.

FIG. 2 provides models of exemplary ways to combine a tube bottom to a tube neck to form a FACS tube in accordance with an embodiment of the invention.

FIG. 3 provides an exemplary concept for manufacturing a plurality of containers, in accordance with an embodiment of the invention.

FIG. 4 provides an embodiment of a method of dispensing reagents into a shortened tube or tube bottom before assembling a full FACS tube, in accordance with an embodiment of the invention.

FIG. 5 provides calculations to demonstrate how many 100 nl reagent dispenses can be accommodated in a 5 ml FACS tube in accordance with an embodiment of the invention.

FIG. 6 provides an embodiment of a tube bottom having reagent compositions positioned on the inner surface thereof in accordance with an embodiment of the invention.

FIG. 7 provides a picture of an assembled FACS tube containing a liquid in accordance with an embodiment of the invention.

### DETAILED DESCRIPTION

Containers including one or more dried reagent compositions are provided. Aspects of a subject containers may include a container bottom portion defining a first volume and comprising a first dried reagent composition positioned on an inner surface thereof, and a container wall portion attached to the container bottom portion at a sealed attachment region joining the container bottom portion to the container wall portion. Also provided are methods of making and using the containers, as well as kits including the same.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, containers including one or more dried reagent compositions are provided. In further describing various embodiments of the invention, the subject containers are first described in greater detail. Next, methods of making the containers are described. In addition, methods of using the subject containers, as well as kits that include the subject containers, are also provided.

### Container

Aspects of the present disclosure include containers. In certain embodiments, the containers are useful in assays, for example, assays of a liquid sample, such as a biological sample, e.g., for the presence of one or more analytes in the sample. Containers according to certain embodiments of the present disclosure include a container bottom portion defining a first volume and comprising a first dried reagent composition positioned on an inner surface thereof, and a container wall portion attached to the container bottom portion at a liquid seal attachment region joining the container bottom portion to the container wall portion.

The container can be any convenient container that is compatible with the liquid sample and/or reagent(s) or analyte(s) that may be in contact with the container. For example, the container can be a liquid-compatible container configured to contain a liquid sample. In some cases, the liquid sample may be an aqueous liquid sample, and in these cases, the container may be compatible with aqueous samples. By “compatible” is meant that the container (e.g., the material the container is made of) is substantially inert with respect to (e.g., does not significantly react with) the liquid and/or reagent(s) or analyte(s) in contact with the container.

The container may be configured to hold a certain volume of a fluid (e.g., gas or liquid). In certain embodiments, the container is configured as a liquid container. For example, the liquid container may be configured to hold a volume of a liquid. The size of the liquid container may depend on the volume of liquid to be held in the liquid container. For instance, the liquid container may be configured to hold a volume (e.g., a volume of a liquid) ranging from 0.1 nl to 1000 ml, such as from 0.1 ml to 900 ml, or 0.1 ml to 800 ml, or 0.1 ml to 700 ml, or 0.1 ml to 600 ml, or 0.1 ml to 500 ml, or 0.1 ml to 400 ml, or 0.1 ml to 300 ml, or 0.1 ml to 200 ml, or 0.1 ml to 100 ml, or 0.1 ml to 50 ml, or 0.1 ml to 25 ml, or 0.1 ml to 10 ml, or 0.1 ml to 5 ml, or 0.1 ml to 1 ml, or 0.1 ml to 0.5 ml. In certain instances, the liquid container is configured to hold a volume (e.g., a volume of a liquid) ranging from 0.1 ml to 200 ml, such as 0.5 ml to 100 ml, e.g., 1.0 ml to 50 ml.

The container, e.g., fully assembled container, may include separate portions that are coupled, e.g., joined or attached, to one another. In some instances, the container includes a container bottom portion and a container wall portion that are attached together to form the container. The container bottom portion and container wall portion may be attached in a manner such that when the fully assembled container is held upright, the container bottom portion forms the closed bottom end of the container and the container wall portion forms container walls rising from the container bottom portion. The container wall portion of the container may form an opening for receiving a sample, where the opening is present at an end of the container that is opposite from the closed bottom end of the container.

The container bottom portion and the container wall portion may be attached by any suitable means. In some instances, the container bottom portion and the container wall portion are permanently (i.e., irreversibly) attached to each other. In other words, the container bottom portion is irreversibly attached to the container wall portion. In some instances, the container wall portion and the container bottom portion are press fitted, snap fitted, or screwed together. In some instances, the container wall portion and the container bottom portion are solvent bonded, adhesive bonded (e.g., glue adhesive bonded), or welded (e.g., friction welded or ultrasonically welded) to each other.

The container wall portion may be attached to the container bottom portion at a sealed attachment region joining the container bottom portion to the container wall portion. The sealed attachment region in an attachment or joining region between the bottom and wall portions, which is configured to prevent passage of a fluid, e.g., a liquid from the interior to the exterior of the container. That is, the seal attachment region may substantially prevent, if not complete inhibit, the contents of the container (e.g., liquid inside the liquid container) from exiting the container at the liquid seal attachment region (such that it may be referred to as a liquid seal attachment reason, since it is an attachment region that serves as a seal to prevent the passage of liquid). For example, the sealed attachment region may include a watertight seal at the interface between the container bottom portion and the container wall portion. The sealed attachment region may include a connection line indicating an interface between the container bottom portion and the container wall portion. In some embodiments, a seal or gasket may be used in the sealed attachment region. For example, the connection line may indicate where the container bottom portion and the container wall portion meet and attach to one another. In some instances, the connection line extends around or across the perimeter of a cross-section of the container. In some instances, the connection line extends around or across a portion of the perimeter of a cross-section of the container. The connection line may have any suitable combination of straight and curved lines. In some instances, the connection line is a straight line.

The bottom portion may include a closed end and a wall rising therefrom. The container bottom portion may have an inner surface and an outer surface. The inner surface of the container bottom portion may be the surface of the container bottom portion facing toward the inside of the container bottom portion. The inner surface may be in contact with the contents of the container once the container is assembled. One or more dried reagent compositions, as described below, may be positioned on the inner surface of the container bottom portion. The outer surface of the container bottom portion is the surface of the container bottom portion facing away from the inside of the container bottom portion. The outer surface does not contact the contents of the container once the container is assembled. In some embodiments, a coating may be applied to the internal surface to alter material properties, improve dispense adhesion and/or separation. Any convenient type of coating capable of imparting such functional may be employed, as desired. In some instances, the container bottom portion includes the bottom closed end of a tube or vial including, e.g., a rounded closed end of a tube or vial. The closed end and wall rising therefrom may have any suitable cross-sectional shape including, e.g., rectilinear cross sectional shapes, e.g., squares, rectangles, trapezoids, triangles, hexagons, etc., curvilinear cross-sectional shapes, e.g., circles, ovals, as well as irregular shapes, e.g., a parabolic shape.

The container bottom portion may have any suitable dimensions. In some such as 0.1 to 3 cm and including 1.1 to 2 cm. In some instances, the container bottom portion has a width, e.g., diameter, ranging from 0.1 to 15 cm, such as 0.1 to 3 cm and including 1.0 to 2 cm. In some instances, the first volume defined by the container bottom portion ranges from 0.01 to 1000 ml, such as 0.01 to 50 ml and including 0.1 to 0.6 ml.

The container wall portion may include an elongated member having a wall that is joined at one end to the container bottom portion, such as described above, and an open top end distal to the container bottom portion. In some instances, the container wall portion is configured as a neck of a tube or vial. The elongated member may have any suitable cross-sectional shape including, e.g., rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic shape. The container wall portion may have any suitable dimensions. In some instances, the container wall portion has a height (i.e., dimension running the length of the elongated member from the end that is joined to the container bottom portion to the open top end) ranging from 0.5 to 100 cm, such as 0.5 to 15 cm and including 3 to 8. In some instances, the container wall portion has a width, e.g., diameter, ranging from 0.1 to 15 cm, such as 0.1 to 3 cm and including 1.0 to 2 cm, where in some instances the container wall portion has width dimensions that match the width dimensions of the container bottom portion. In some instances, the container wall portion defines a volume ranging from 0.5 to 1000 ml, such as 0.5 to 20 ml and including 3 to 8 ml.

The shape of the fully assembled container, i.e., container made up of a container bottom portion and container wall portion attached to each other, e.g., as described above, may vary and may depend on the use of the container. For example, as described herein, the container may find use in an assay, such as an assay of a liquid sample (e.g., a biological sample). In these cases, the container may be configured in a shape that is compatible with the assay and/or the method or other devices used to perform the assay. In some embodiments, the container may be applied to blood collection. For instance, the container may be configured in a shape of typical laboratory equipment used to perform the assay or in a shape that is compatible with other devices used to perform the assay. As described above, the container may be configured as a liquid container. In these embodiments, the liquid container may be a vial or a test tube. In certain cases, the liquid container is a vial. In certain cases, the liquid container is a test tube. As described above, the liquid container may be configured to hold a volume (e.g., a volume of a liquid). In embodiments where the liquid container is a vial or a test tube, the liquid container may be configured to hold a volume (e.g., a volume of a liquid) ranging from 1*10\hat{ }-7 ml to 1000 ml, such as from 0.5 ml to 900 ml, or 0.5 ml to 800 ml, or 0.5 ml to 700 ml, or 0.5 ml to 600 ml, or 0.5 ml to 500 ml, or 0.5 ml to 400 ml, or 0.5 ml to 300 ml, or 0.5 ml to 200 ml, or 0.5 ml to 100 ml, or 0.5 ml to 50 ml, or 0.5 ml to 25 ml, or 0.5 ml to 10 ml, or 0.5 ml to 5 ml, or 1 ml to 5 ml. In certain instances, the vial or test tube is configured to hold a volume (e.g., a volume of a liquid) ranging from 0.5 ml to 5 ml.

As described above, embodiments of the container can be compatible with the liquid sample and/or reagent(s) or analyte(s) in contact with the container. Examples of suitable container materials include, but are not limited to, glass and plastic. For example, the container may be composed of glass, such as, but not limited to, silicate glass, borosilicate glass, sodium borosilicate glass (e.g., PYREX™), fused quartz glass, fused silica glass, and the like. Other examples of suitable container materials include plastics, such as, but not limited to, polystyrene, polypropylene, polymethylpentene, polytetrafluoroethylene (PTFE), perfluoroethers (PFE), fluorinated ethylene propylene (FEP), perfluoroalkoxy alkanes (PFA), polyethylene terephthalate (PET), polyethylene (PE), polyetheretherketone (PEEK), and the like.

In some embodiments, as described above, the container is configured to hold a certain volume of a fluid (e.g., gas or liquid). In some instances, the container is configured for holding a certain volume of a liquid (e.g., a liquid container). In some embodiments where the container is configured as a liquid container, the liquid container may be sealed. That is, the liquid container may include a seal that substantially prevents the contents of the liquid container (e.g., liquid inside the liquid container) from exiting the liquid container. The seal of the liquid container may also substantially prevent other substances from entering the liquid container. For example, the seal may be a water-tight seal that substantially prevents liquids from entering or exiting the container, or may be an air-tight seal that substantially prevents gases from entering or exiting the container. In some instances, the seal is a removable or breakable seal, such that the contents of the liquid container may be exposed to the surrounding environment when so desired, e.g., if it is desired to remove a portion of the contents of the liquid container. In some instances, the seal is made of a resilient material to provide a barrier (e.g., a water-tight and/or air-tight seal) for retaining a sample in the container. Particular types of seals include, but are not limited to, films, such as polymer films, caps, etc., depending on the type of container. Suitable materials for the seal include, for example, rubber or polymer seals, such as, but not limited to, silicone rubber, natural rubber, styrene butadiene rubber, ethylene-propylene copolymers, polychloroprene, polyacrylate, polybutadiene, polyurethane, styrene butadiene, and the like, and combinations thereof. For example, in certain embodiments, the seal is a septum pierceable by a needle, syringe, or cannula. The seal may also provide convenient access to a sample in the container, as well as a protective barrier that overlies the opening of the container. In some instances, the seal is a removable seal, such as a threaded or snap-on cap or other suitable sealing element that can be applied to the opening of the container. For instance, a threaded cap can be screwed over the opening before or after a sample has been added to the container.

As described above, the container may be configured to hold a certain volume of a fluid (e.g., gas or liquid). In some instances, the container (e.g., a liquid container) has an inner surface and an outer surface. In these embodiments, the inner surface of the container is the surface of the container (e.g., container) facing toward the inside of the container. The inner surface may be in contact with the contents of the container. As such, the container may include an inner surface of the container, such as an inner surface of a liquid container. The outer surface of the container is the surface of the container facing away from the inside of the container. The outer surface does not contact the contents of the container. As such, the container may include an outer surface of the container, such as an outer surface of a liquid container.

As reviewed above, the container, e.g., the container bottom portion, may include a dried reagent composition. In certain embodiments, the dried reagent composition is positioned on a surface (e.g., inner surface) of the container. In some instances, the dried reagent composition is positioned on the inner surface of the container bottom portion. The container may include one or more dried reagent compositions (e.g., dye compositions) on a container surface such as the inner surface of the container bottom portion, such as 2 or more dried reagent compositions, or 3 or more, or 4 or more, or 5 or more, or 6 or more, or 7 or more, or 8 or more, or 9 or more, or 10 or more, or 11 or more, or 12 or more, or 13 or more, or 14 or more, or 15 or more, 16 or more, or 17 or more, or 18 or more, or 19 or more, or 20 or more, or 25 or more, or 30 or more, or 35 or more, or 40 or more, or 45 or more, or 50 or more dried reagent compositions on the inner surface of the container bottom portion. In some embodiments, the container includes 2 to 50 dried reagent compositions on the inner surface, such as 2 to 40, or 2 to 30 or 2 to 20 or 2 to 15, or 2 to 10, or 2 to 7, or 2 to 5 dried reagent compositions on the inner surface. For example, the container may include 2, or 3, or 4, or 5, or 6, or 7, or 8, or 9, or 10, or 11, or 12, or 13, or 14, or 15, or 16, or 17, or 18, or 19, or 20 dried reagent compositions on the inner surface of the container bottom portion. In certain cases, the container includes 2 dried reagent compositions on the inner surface of the container bottom portion. In certain cases, the container includes 5 dried reagent compositions on the inner surface of the container bottom portion. In certain cases, the container includes 7 dried reagent compositions on the inner surface of the container bottom portion. In certain cases, the container includes 10 dried reagent compositions on the inner surface of the container bottom portion. In certain cases, the container includes 15 dried reagent compositions on the inner surface of the container bottom portion.

As described above, the container may include two or more dried reagent compositions positioned relative to a surface of the container (e.g., the inner surface of the container bottom portion). In some instances, the container bottom portion may include a second dried reagent composition positioned on the inner surface thereof. In some instances, the first and second, e.g., two or more, dried reagent compositions are adhered to the inner surface of the container bottom portion. By adhered is meant that the dried reagent compositions are stably associated with the location of the inner surface where they are positioned, such that they do not move from the location of the inner surface where they are positioned when in the dry state. Upon reconstitution, the reagents, e.g., dyes, of the dried reagent compositions are dissociated from the surface location where they are positioned, such that they are present in the liquid that was employed to reconstitute the dried reagent compositions. The dried reagent compositions may be located on the inner surface of the container bottom portion in distinct positions. For example, first and second dried reagent compositions may be distinctly positioned on the inner surface of the container bottom portion. By “distinct position” or “distinctly positioned” is meant that a dried reagent composition is disposed at a position different from the position of another dried reagent composition. The position of a dried reagent composition may refer to the location of the dried reagent composition on the surface of the container, and/or may refer to the position of the dried reagent composition relative to the surface of the container. In some cases, a dried reagent composition occupies a defined volume of space. For example, a dried reagent composition may occupy a volume of space on a surface of the container. A distinctly positioned dried reagent composition may occupy a volume of space that does not significantly coincide or overlap with a volume of space occupied by another dried reagent composition, where in some instances it does not coincide or overlap at all with a volume of space occupied by another dried reagent composition. Embodiments where dried reagent compositions are distinctly positioned may provide for a minimization in interactions, e.g., dye-dye interactions, between each of the dried reagent compositions.

Stated another way, a distinctly positioned dried reagent composition is not significantly mixed together with another dried reagent composition (e.g., polymeric dye composition), e.g., substantially no portion of the distinctly positioned dried reagent composition is mixed with a portion of another dried reagent composition (e.g., polymeric dye composition). In some instances, a distinctly positioned dried reagent composition is not mixed together with another dried reagent composition (e.g., polymeric dye composition), e.g., no portion of the distinctly positioned dried reagent composition is mixed with a portion of another dried reagent composition (e.g., polymeric dye composition). In certain embodiments, a distinctly positioned dried reagent composition includes a single reagent. For example, a distinctly positioned dried reagent composition may be substantially composed of a single reagent and does not include another reagent in a significant amount. A distinctly positioned dried reagent composition may include a large excess of a reagent with respect to any other reagent that may be in the dried reagent composition, such as, for example, 75 wt % or more, such as 80 wt % or more, or 85 wt % or more, or 90 wt % or more, or 95 wt % or more, or 97 wt % or more or 99 wt % or more, or 100 wt % of a reagent with respect to any other reagent that may be in the dried reagent composition. In certain embodiments, a distinctly positioned dried reagent composition includes a single dye. For example, a distinctly positioned dried reagent composition may be substantially composed of a single dye and does not include another dye in a significant amount. A distinctly positioned dried reagent composition may include a large excess of a dye with respect to any other dye that may be in the dried reagent composition, such as, for example, 75 wt % or more, such as 80 wt % or more, or 85 wt % or more, or 90 wt % or more, or 95 wt % or more, or 97 wt % or more or 99 wt % or more, or 100 wt % of a dye with respect to any other dye that may be in the dried reagent composition. In some instances, the dried reagent composition(s) include two or more reagents. In some instances, the first and/or second dried reagent composition includes two or more reagents including, e.g., three or more reagents, four or more reagents, five or more reagents, six or more reagents, seven or more reagents, eight or more reagents, nine or more reagents, or ten or more reagents. In some instances, the dried reagent composition(s) include two or more dyes. In some instances, the first and/or second dried reagent composition includes two or more dyes including, e.g., three or more dyes, four or more dyes, five or more dyes, six or more dyes, seven or more dyes, eight or more dyes, nine or more dyes, or ten or more dyes.

In some instances, distinctly positioned dried reagent compositions are spaced apart from each other at separate locations on the surface of the container. A dried reagent composition that is spaced apart from another dried reagent composition may be physically separated from adjacent dried reagent compositions. For instance, distinctly positioned dried reagent compositions may be positioned on the surface of the container at separate locations such that there is a certain distance between an edge of the dried reagent composition and an edge of an adjacent dried reagent composition. In some embodiments, the distance between the separate locations of the dried reagent compositions on the surface of the container is 0.1 mm or more, such as 0.5 mm or more, or 1 mm or more, or 2 mm or more, or 3 mm or more, or 4 mm or more, or 5 mm or more, or 6 mm or more, or 7 mm or more, or 8 mm or more, or 9 mm or more, or 10 mm or more, or 12 mm or more, or 14 mm or more, or 16 mm or more, or 18 mm or more, or 20 mm or more, or 25 mm or more or 30 mm or more, or 35 mm or more, or 40 mm or more, or 50 mm or more, or 60 mm or more, or 70 mm or more, or 80 mm or more, or 90 mm or more, or 100 mm or more, or 110 mm or more, or 120 mm or more, or 130 mm or more, or 140 mm or more, or 150 mm or more, or 160 mm or more, or 170 mm, or more, or 180 mm or more, or 190 mm or more, or 200 mm or more. For example, the distance between the separate locations of the dried reagent compositions on the surface of the container may range from 0.1 mm to 200 mm, such as from 0.1 mm to 190 mm, or 0.1 mm to 180 mm, or 0.1 mm to 170 mm, or 0.1 mm to 160 mm, or 0.1 mm to 150 mm, or 0.1 mm to 140 mm, or 0.1 mm to 130 mm, or 0.1 mm to 120 mm, or 0.1 mm to 110 mm, or 0.1 mm to 100 mm, or 0.1 mm to 90 mm, or 0.1 mm to 80 mm, or 0.1 mm to 70 mm, or 0.1 mm to 60 mm, or 0.1 mm to 50 mm, or 0.1 mm to 40 mm, or 0.1 mm to 30 mm, or 0.1 mm to 20 mm, or 0.1 mm to 10 mm, or 0.1 mm to 9 mm, or 0.1 mm to 8 mm, or 0.1 mm to 7 mm, or 0.1 mm to 6 mm, or 0.1 mm to 5 mm, or 0.1 mm to 4 mm, or 0.1 mm to 3 mm, or 0.1 mm to 2 mm, or 0.1 mm to 1 mm, or 0.1 mm to 0.5 mm. In certain instances, the distance between the separate locations of the dried reagent compositions on the surface of the container ranges from 0.1 mm to 200 mm. In some cases, the distance between the separate locations of the dried reagent compositions on the surface of the container ranges from 0.1 mm to 10 mm.

In certain embodiments, distinctly positioned dried reagent compositions are positioned adjacent to each other on the inner surface of the container (e.g., container bottom portion), but are not spaced apart from each other. In these instances, an edge of a dried reagent composition may contact the edge of an adjacent dried reagent composition. For example, the volume of space occupied by a dried reagent composition may contact, but not significantly overlap with a volume of space occupied by another (adjacent) dried reagent composition. In these embodiments, adjacent dried reagent compositions may contact each other, but are not significantly mixed together, e.g., substantially no portion of the distinctly positioned dried reagent composition is mixed with a portion of another (adjacent) dried reagent composition.

Distinctly positioned dried reagent compositions may be present on the same surface of the container (e.g., inner surface of the container bottom portion), but may be disposed at different positions on or relative to the surface of the container (e.g., the inner surface of the container bottom portion). For example, as described above, the container may be configured as a liquid container and, as such, may include an inner surface and an outer surface. In certain instances, the dried reagent compositions are positioned on a surface of the liquid container (e.g., inner surface of the container bottom portion). In some cases, the dried reagent compositions are distinctly positioned on an inner surface of the liquid container (e.g., inner surface of the container bottom portion).

Examples of distinctly positioned dried reagent compositions include embodiments where a dried reagent composition is disposed on a surface of a container (e.g., inner surface of the container bottom portion) at a certain location and another dried reagent composition is also disposed on the surface of the container at a different location. As such, the distinctly positioned dried reagent compositions may be positioned at separate locations on the surface of the container. For example, embodiments of the containers may include first and second dried reagent compositions, where the first dried reagent composition is positioned at a certain location on the inner surface of the container bottom portion and the second dried reagent composition is positioned on the inner surface of the container bottom portion at a different location than the first dried reagent composition. As described above, the first and second dried reagent compositions may be spaced apart from each other such that there is a distance between the separate locations of the first and second dried reagent compositions on the surface of the container (e.g., inner surface of the container bottom portion). The distance between the first and second dried reagent compositions may be according to the ranges and values as described above.

The dried reagent composition(s) may have any suitable dimensions. In some instances, the first and second dried reagent compositions have the same dimensions. In certain embodiments, the first and second dried reagent compositions include different dimensions. The dried reagent compositions may have any suitable cross-sectional shape including, e.g., rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic shape. In some instances, the first and second dried reagent compositions have a diameter ranging from 0.01 mm to 5 mm including, e.g., from 0.01 mm to 4 mm, from 0.01 mm to 3 mm, from 0.01 to 2 mm, from 0.01 to 1 mm, from 0.1 mm to 5 mm, from 0.1 mm to 4 mm, from 0.1 mm to 3 mm, from 0.1 to 2 mm, from 0.1 to 1 mm, from 0.5 mm to 5 mm, from 0.5 mm to 4 mm, from 0.5 mm to 3 mm, from 0.5 to 2 mm, from 0.5 to 1 mm. In some instances, the first and second dried reagent compositions include a surface area ranging from 5×10⁻⁵ mm² to 20 mm² including, e.g., 5×10⁻⁵ mm² to 20 mm², 5×10⁻³ mm² to 20 mm², 0.1 mm² to 20 mm², 5×10⁻⁵ mm² to 0.5 mm², 5×10⁻³ mm² to 0.5 mm², 0.1 mm² to 0.5 mm².

Additional dried reagent compositions may be provided on the inner surface of the container (e.g., inner surface of the container bottom portion). For example, the container may include a third dried reagent composition (e.g., dye composition) distinctly positioned on the inner surface of the container bottom portion. The third dried reagent composition may be distinctly positioned relative to the first dried reagent composition, and also may be distinctly positioned relative to the second dried reagent composition. As such, each of the dried reagent compositions (e.g., first, second and third dried reagent compositions) may be distinctly positioned relative to each other on the inner surface of the container bottom portion, as described herein. Additional distinctly positioned dried reagent compositions may be provided on the surface of the container, such as 4 or more distinctly positioned dried reagent compositions, or 5 or more, 7 or more, 10 or more, etc., as described above. In some instances, the dried reagent compositions are adhered to the inner surface of the container bottom portion.

Additional examples of distinctly positioned dried reagent compositions include embodiments where a dried reagent composition is disposed on a surface of a container (e.g., inner surface of the container bottom portion) at a certain location and another dried reagent composition is located at the same location. As such, the distinctly positioned dried reagent compositions may be co-located at the same location of the surface of the container (e.g., inner surface of the container bottom portion). Dried reagent compositions may be co-located at the same location yet still be distinctly positioned. For example, dried reagent compositions may be separated from each other by a non-dye material. In some cases, the non-dye material is interposed between distinctly positioned dried reagent compositions. The non-dye material may substantially cover a surface of a dried reagent composition such that an adjacent dried reagent composition is separated from the dried reagent composition. For instance, a dried reagent composition may have a non-dye material disposed over the surface of the dried reagent composition, and another dried reagent composition may be disposed on a surface of the non-dye material. In these instances, the dried reagent composition may be physically separated from other dried reagent compositions by the non-dye material. In some cases, the distinctly positioned dried reagent compositions may be provided as alternating layers of a dried reagent composition and a non-dye material on a surface of the container. As such, in certain embodiments, two or more dried reagent compositions are distinctly positioned relative to each other and are also co-located at the same location of the surface of the container.

In certain embodiments, the non-dye material is a material compatible with other assay components (e.g., reagents, buffers, analytes, etc.) that may be present in the container during use. The non-dye material may be substantially inert with respect to the other assay components (e.g., reagents, buffers, analytes, etc.) that may be present in the container during use such that there is no significant reaction between the non-dye material and the other assay components. Examples of non-dye materials include, but are not limited to, stabilizers, buffers, soluble inert materials (e.g., aqueous soluble inert materials), and the like. Stabilizers of interest include, but are not limited to: sugars and polyalcohols. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (p-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof. Non-dye materials may include, for example, bovine serum albumin (BSA), sodium azide, glycerol, phenylmethanesulfonyl fluoride (PMSF), ethylenediaminetetraacetic acid (EDTA), buffered citrate, phosphate buffered saline (PBS), sodium chloride, paraformaldehyde, and the like, and combinations thereof.

For example, embodiments of the containers may include first and second dried reagent compositions, where the first dried reagent composition is positioned at a certain location on the surface of the container (e.g., the inner surface of the container bottom portion) and the second dried reagent composition is co-located at the same location as the first dried reagent composition. As described above, the first and second dried reagent compositions may be spaced apart from each other such that there is a distance between the first and second dried reagent compositions. For instance, the first and second dried reagent compositions may be separated from each other by a non-dye material, as described above. The distance between the first and second dried reagent compositions may be according to the ranges and values as described above. For example, the non-dye material may be interposed between the distinctly positioned first and second dried reagent compositions. In these embodiments, the first dried reagent composition may be positioned on a surface of the container, the non-dye material may be disposed as a layer on a surface of the first dried reagent composition, and the second dried reagent composition may be disposed on the surface of the non-dye composition. In these instances, the first dried reagent composition may be physically separated from the second dried reagent compositions by the non-dye material. As such, in certain embodiments, the first and second dried reagent compositions are distinctly positioned relative to each other and are also co-located at the same location of the surface of the container. For example, the layer of non-dye material on the surface of the first dried reagent composition may substantially cover the entire surface of the first dried reagent composition. In these instances, a second dried reagent composition disposed on the surface of the non-dye composition may not significantly contact the first dried reagent composition. In some cases, the non-dye material is a substantially contiguous layer of non-dye material on the surface of the first dried reagent composition. For example, the non-dye material may cover a substantial portion of the surface of the first dried reagent composition, such as 75% or more of the surface of the first dried reagent composition, or 80% or more, or 85% or more, or 90% or more, or 95% or more, or 97% or more, or 99% or more of the surface of the first dried reagent composition. Embodiments where the surface of the first dried reagent composition is substantially covered by the non-dye material may provide for a minimization in dye-dye interactions between the first and second dried reagent compositions.

In certain embodiments, the non-dye material has a thickness ranging from 0.01 mm to 5 mm, such as from 0.05 mm to 5 mm, or 0.1 mm to 5 mm, or 0.1 mm to 4 mm, or 0.1 mm to 3 mm, or 0.1 mm to 2 mm, or 0.1 mm to 1 mm, or 0.1 mm to 0.9 mm, or 0.1 mm to 0.8 mm, or 0.1 mm to 0.7 mm, or 0.1 mm to 0.6 mm, or 0.1 mm to 0.5 mm. In certain instances, the non-dye material has a thickness from 0.1 mm to 1 mm. In some cases, the non-dye material has a thickness from 0.1 mm to 0.05 mm.

Additional dried reagent compositions may also be provided. For example, the container may include a third dried reagent composition distinctly positioned relative to the first and second dried reagent compositions. As such, the third dried reagent composition may be distinctly positioned relative to the first dried reagent composition, and also may be distinctly positioned relative to the second dried reagent composition. Thus, each of the dried reagent compositions (e.g., first, second and third dried reagent compositions) may be distinctly positioned relative to each other, as described herein. In some cases, each of the dried reagent compositions may be separated from each other by a non-dye material. For instance, each of the dried reagent compositions may be separated from each other by a non-dye material. In some cases, the non-dye material is interposed between each of the distinctly positioned dried reagent compositions. In certain instances, each of the distinctly positioned dried reagent compositions is provided as a layer with a layer of the non-dye material in between each of the distinctly positioned dried reagent compositions. Additional layers of distinctly positioned dried reagent compositions may be provided, such as 4 or more distinctly positioned dried reagent compositions, or 5 or more, 7 or more, 10 or more, etc., as described above. As such, a plurality of dried reagent compositions can be distinctly positioned relative to each other and also co-located at the same location of the surface of the container (e.g., the inner surface of the container bottom portion).

In certain embodiments, the dried reagent compositions on the surface of the container are dried dye compositions that, e.g., include a dye. A dried dye composition is a dye composition that includes a low amount of solvent. For example, dried dye compositions may include a low amount of a liquid, such as water. In some cases, a dried dye composition includes substantially no solvent. For instance, dried dye compositions may include substantially no liquid, such as water. In certain embodiments, a dried dye composition includes 25 wt % or less solvent, such as 20 wt % or less, or 15 wt % or less, or 10 wt % or less, or 5 wt % or less, or 3 wt % or less, or 1 wt % or less, or 0.5 wt % or less solvent. In some cases, a dried dye composition is not a fluid. In some cases, a dried dye composition is substantially a solid. For example, a dried dye composition may have a high viscosity, such as a viscosity of 10,000 cP or more, or 25,000 cP or more, or 50,000 cP or more, or 75,000 cP or more, or 100,000 cP or more, or 150,000 cP or more, or 200,000 cP or more, or 250,000 cP or more at standard conditions.

In some instances, the dye compositions are lyophilized dye compositions. In certain cases, a lyophilized dye composition is a dye composition where water has been removed from the dye composition by sublimation, where the water in the dye composition undergoes a phase transition from a solid to a gas. For example, a lyophilized dye composition may be a dye composition where water has been removed from the composition by freezing the dye composition (e.g., freezing water in the dye composition) and then reducing the pressure surrounding the dye composition such that the water in the dye composition undergoes sublimation. In certain instances, a lyophilized dye composition includes water in a low amount, such as 25% or less, or 20% or less, or 15% or less, or 10% or less, or 9% or less, or 8% or less, or 7% or less, or 6% or less, or 5% or less, or 4% or less, or 3% or less, or 2% or less, or 1% or less, or 0.5% or less, or 0.25% or less, or 0.1% or less water as measured by Karl Fischer (KF) titration. In some cases, a lyophilized dye composition has 3% or less water as measured by Karl Fischer titration. In some cases, a lyophilized dye composition has 1% or less water as measured by Karl Fischer titration. In some cases, a lyophilized dye composition has 0.5% or less water as measured by Karl Fischer titration. Lyophilized dye compositions may include additives and/or excipients, such as a stabilizer. In some cases, the lyophilized dye composition includes a stabilizer, such as a sugar or a polyalcohol. Sugars and polyalcohols suitable for use in lyophilized dye compositions include sugars that are compatible with the other reagents, buffers, dyes and sample components being used. Examples of suitable sugars include, but are not limited to, sucrose, maltose, trehalose, 2-hydroxypropyl-beta-cyclodextrin (p-HPCD), lactose, glucose, fructose, galactose, glucosamine, and the like, and combinations thereof. In certain instances, the sugar is a disaccharide. For example, the disaccharide may be sucrose. Examples of suitable polyalcohols include, but are not limited to, mannitol, glycerol, erythritol, threitol, xylitol, sorbitol, and the like, and combinations thereof.

The dye in the dye composition may be used as a detectable label. In certain cases, the dye includes detectable moieties or markers that are detectible based on, for example, fluorescence emission maxima, fluorescence polarization, fluorescence lifetime, light scatter, mass, molecular mass, or combinations thereof. In certain embodiments, the detectable label is a fluorophore (i.e., a fluorescent label, fluorescent dye, etc.). Fluorophores of interest may include, but are not limited to, dyes suitable for use in analytical applications (e.g., flow cytometry, imaging, etc.).

In some instances, the fluorophore is polymeric dye. In some instances of the method, the polymeric dye includes a conjugated polymer. Conjugated polymers (CPs) are characterized by a delocalized electronic structure which includes a backbone of alternating unsaturated bonds (e.g., double and/or triple bonds) and saturated (e.g., single bonds) bonds, where 7-electrons can move from one bond to the other. As such, the conjugated backbone may impart an extended linear structure on the polymeric dye, with limited bond angles between repeat units of the polymer. For example, proteins and nucleic acids, although also polymeric, in some cases do not form extended-rod structures but rather fold into higher-order three-dimensional shapes. In addition, CPs may form “rigid-rod” polymer backbones and experience a limited twist (e.g., torsion) angle between monomer repeat units along the polymer backbone chain. In some instances, the polymeric dye includes a CP that has a rigid rod structure. The structural characteristics of the polymeric dyes can have an effect on the fluorescence properties of the molecules.

Polymeric dyes of interest include, but are not limited to, those dyes described by Gaylord et al. in U.S. Publication Nos. 20040142344, 20080293164, 20080064042, 20100136702, 20110256549, 20110257374, 20120028828, 20120252986, 20130190193, 20160264737, 20160266131, 20180231530, 20180009990, 20180009989, and 20180163054, the disclosures of which are herein incorporated by reference in their entirety; and Gaylord et al., J. Am. Chem. Soc., 2001, 123 (26), pp 6417-6418; Feng et al., Chem. Soc. Rev., 2010, 39, 2411-2419; and Traina et al., J. Am. Chem. Soc., 2011, 133 (32), pp 12600-12607, the disclosures of which are herein incorporated by reference in their entirety.

The polymeric dye may have one or more desirable spectroscopic properties, such as a particular absorption maximum wavelength, a particular emission maximum wavelength, extinction coefficient, quantum yield, and the like (see e.g., Chattopadhyay et al., “Brilliant violet fluorophores: A new class of ultrabright fluorescent compounds for immunofluorescence experiments.” Cytometry Part A, 81A(6), 456-466, 2012). In some embodiments, the polymeric dye has an absorption curve between 280 nm and 475 nm. In certain embodiments, the polymeric dye has an absorption maximum (excitation maximum) in the range 280 nm and 475 nm. In some embodiments, the polymeric dye absorbs incident light having a wavelength in the range between 280 nm and 475 nm. In some embodiments, the polymeric dye has an emission maximum wavelength ranging from 400 nm to 850 nm, such as 415 nm to 800 nm, where specific examples of emission maxima of interest include, but are not limited to: 421 nm, 510 nm, 570 nm, 602 nm, 650 nm, 711 nm and 786 nm. In some instances, the polymeric dye has an emission maximum wavelength in a range selected from the group consisting of 410 nm to 430 nm, 500 nm to 520 nm, 560 nm to 580 nm, 590 nm to 610 nm, 640 nm to 660 nm, 700 nm to 720 nm, and 775 nm to 795 nm. In certain embodiments, the polymeric dye has an emission maximum wavelength of 421 nm. In some instances, the polymeric dye has an emission maximum wavelength of 510 nm. In some cases, the polymeric dye has an emission maximum wavelength of 570 nm. In certain embodiments, the polymeric dye has an emission maximum wavelength of 602 nm. In some instances, the polymeric dye has an emission maximum wavelength of 650 nm. In certain cases, the polymeric dye has an emission maximum wavelength of 711 nm. In some embodiments, the polymeric dye has an emission maximum wavelength of 786 nm. In certain instances, the polymeric dye has an emission maximum wavelength of 421 nm±5 nm. In some embodiments, the polymeric dye has an emission maximum wavelength of 510 nm±5 nm. In certain instances, the polymeric dye has an emission maximum wavelength of 570 nm±5 nm. In some instances, the polymeric dye has an emission maximum wavelength of 602 nm±5 nm. In some embodiments, the polymeric dye has an emission maximum wavelength of 650 nm±5 nm. In certain instances, the polymeric dye has an emission maximum wavelength of 711 nm±5 nm. In some cases, the polymeric dye has an emission maximum wavelength of 786 nm±5 nm. In certain embodiments, the polymeric dye has an emission maximum selected from the group consisting of 421 nm, 510 nm, 570 nm, 602 nm, 650 nm, 711 nm and 786 nm.

Specific polymeric dyes that may be employed include, but are not limited to, BD Horizon Brilliant™ Dyes, such as BD Horizon Brilliant™ Violet Dyes (e.g., BV421, BV480, BV510, BV570, BV605, BV650, BV711, BV786, BV829); BD Horizon Brilliant™ Ultraviolet Dyes (e.g., BUV395, BUV496, BUV563, BUV615, BUV661, BUV737, BUV805); and BD Horizon Brilliant™ Blue Dyes (e.g., BB515, BB630, BB660, BB700, BB755, BB790) (BD Biosciences, San Jose, Calif.).

In certain embodiments, as described above, the container (e.g., the container bottom portion) includes more than one dye composition, such as, for example, two dye compositions (e.g., first and second dye compositions). In these embodiments, the dye compositions can be polymeric dye compositions, as described above. For example, the container may include first and second polymeric dye compositions. As described above, the first and second polymeric dyes may be conjugated polymers (CPs). In certain cases, the first and second polymeric dyes are water soluble conjugated polymers, as described above. In some instance, the dye compositions included in the container may be different dye compositions, such as different polymeric dye compositions. Different dye compositions may differ from each other in terms of chemical composition and/or in terms of one or more properties of the dyes. For instance, different dye compositions may differ from each other by at least one of excitation maxima and emission maxima. In some cases, different dye compositions differ from each other by their excitation maxima. In some cases, different dye compositions differ from each other by their emission maxima. In some cases, different dye compositions differ from each other by both their excitation maxima and emission maxima. As such, in embodiments that include first and second dyes, the first and second dyes may differ from each other by at least one of excitation maxima and emission maxima. For example, the first and second dyes may differ from each other by excitation maxima, by emission maxima, or by both excitation and emission maxima. Additional dye compositions may be included in the container, where each of the dye compositions in the container differ from each other as described above.

In certain embodiments, the container (e.g., the container bottom portion) also includes other types of dye compositions, such as one or more non-polymeric dye compositions. As discussed above, dyes may include detectable moieties or markers that are detectible based on, for example, fluorescence emission maxima, fluorescence polarization, fluorescence lifetime, light scatter, mass, molecular mass, or combinations thereof. In certain embodiments, the non-polymeric dye includes a fluorophore (i.e., a fluorescent label, fluorescent dye, etc.). Fluorophores of interest may include but are not limited to dyes suitable for use in analytical applications (e.g., flow cytometry, imaging, etc.). A large number of non-polymeric dyes are commercially available from a variety of sources, such as, for example, Molecular Probes (Eugene, Oreg.) and Exciton (Dayton, Ohio). For example, the fluorophore of the non-polymeric dye may be 4-acetamido-4′-isothiocyanatostilbene-2,2′disulfonic acid; acridine and derivatives such as acridine, acridine orange, acrindine yellow, acridine red, and acridine isothiocyanate; 5-(2′-aminoethyl)aminonaphthalene-1-sulfonic acid (EDANS); 4-amino-N-[3-vinylsulfonyl)phenyl]naphthalimide-3,5 disulfonate (Lucifer Yellow VS); N-(4-anilino-1-naphthyl)maleimide; anthranilamide; Brilliant Yellow; coumarin and derivatives such as coumarin, 7-amino-4-methylcoumarin (AMC, Coumarin 120), 7-amino-4-trifluoromethylcouluarin (Coumaran 151); cyanine and derivatives such as cyanosine, Cy3, Cy3.5, Cy5, Cy5.5, and Cy7; 4′,6-diaminidino-2-phenylindole (DAPI); 5′, 5″-dibromopyrogallol-sulfonephthalein (Bromopyrogallol Red); 7-diethylamino-3-(4′-isothiocyanatophenyl)-4-methylcoumarin; diethylaminocoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansyl chloride); 4-(4′-dimethylaminophenylazo)benzoic acid (DABCYL); 4-dimethylaminophenylazophenyl-4′-isothiocyanate (DABITC); eosin and derivatives such as eosin and eosin isothiocyanate; erythrosin and derivatives such as erythrosin B and erythrosin isothiocyanate; ethidium; fluorescein and derivatives such as 5-carboxyfluorescein (FAM), 5-(4,6-dichlorotriazin-2-yl)aminofluorescein (DTAF), 2′7′-dimethoxy-4′5′-dichloro-6-carboxyfluorescein (JOE), fluorescein isothiocyanate (FITC), fluorescein chlorotriazinyl, naphthofluorescein, and QFITC (XRITC); fluorescamine; IR144; IR1446; Green Fluorescent Protein (GFP); Reef Coral Fluorescent Protein (RCFP); Lissamine™; Lissamine rhodamine, Lucifer yellow; Malachite Green isothiocyanate; 4-methylumbelliferone; ortho cresolphthalein; nitrotyrosine; pararosaniline; Nile Red; Oregon Green; Phenol Red; B-phycoerythrin (PE); o-phthaldialdehyde; pyrene and derivatives such as pyrene, pyrene butyrate and succinimidyl 1-pyrene butyrate; Reactive Red 4 (Cibacron™ Brilliant Red 3B-A); rhodamine and derivatives such as 6-carboxy-X-rhodamine (ROX), 6-carboxyrhodamine (R6G), 4,7-dichlororhodamine lissamine, rhodamine B sulfonyl chloride, rhodamine (Rhod), rhodamine B, rhodamine 123, rhodamine X isothiocyanate, sulforhodamine B, sulforhodamine 101, sulfonyl chloride derivative of sulforhodamine 101 (Texas Red), N,N,N′,N′-tetramethyl-6-carboxyrhodamine (TAMRA), tetramethyl rhodamine, and tetramethyl rhodamine isothiocyanate (TRITC); riboflavin; rosolic acid and terbium chelate derivatives; xanthene; carotenoid-protein complexes, such as peridinin-chlorophyll proteins (PerCP); allophycocyanin (APC); or combinations thereof.

In certain embodiments, the dye compositions included in the container (e.g., container bottom portion) include polymeric dye compositions, as described above. In some cases, the dye compositions included in the container include non-polymeric dye compositions, as described above. In some instances, the dye compositions included in the container include both polymeric dye compositions and non-polymeric dye compositions. As described above, each of the dye compositions (e.g., polymeric and non-polymeric dye compositions) may be distinctly positioned on a surface of the container of the container. In some cases, the container includes a plurality of dye compositions as described above. For example, the container may include two or more, such as three or more, distinct polymeric dye compositions and two or more, such as three or more, or four or more, or five or more, distinct non-polymeric dye compositions. In some cases, the container includes three or more distinct polymeric dye compositions and five or more distinct non-polymeric dye compositions.

As described above, the container may include both a polymeric dye composition and a non-polymeric dye composition. In some instances, a polymeric dye composition is mixed with a non-polymeric dye composition. In certain embodiments, the mixture of the polymeric dye composition and the non-polymeric dye composition do not undergo significant dye-dye interactions between the polymeric dye composition and the non-polymeric dye composition. For instance, the fluorescence emission energy of the polymeric dye composition is not significantly quenched by interactions with the non-polymeric dye composition. In some cases, the fluorescence emission energy of the polymeric dye composition is not significantly dissipated by a non-radiative transition. In these embodiments, the detectable fluorescence of the polymeric dye composition is not significantly less than would be expected as compared to the fluorescence of the polymeric dye composition in the absence of the non-polymeric dye composition. Similarly, in some embodiments, the fluorescence emission energy of the non-polymeric dye composition is not significantly quenched by interactions with the polymeric dye composition. For instance, the fluorescence emission energy of the non-polymeric dye composition may not be significantly dissipated by a non-radiative transition. In these embodiments, the detectable fluorescence of the non-polymeric dye composition is not significantly less than would be expected as compared to the fluorescence of the non-polymeric dye composition in the absence of the polymeric dye composition.

In certain embodiments, the dye composition includes a dye, such as a polymeric and/or non-polymeric dye, as described above. The dye composition may also include other components, such as, but not limited to a solvent, a buffer, a stabilizer, and the like. For example, the dye composition may include a stabilizer that reduces and/or substantially prevents degradation of the dye in the dye composition. In some cases, the presence of a stabilizer in the dye composition is sufficient to reduce and/or substantially prevent degradation of the dye in the dye composition for a certain period of time, such as 24 hours or more, or 48 hours or more, or 72 hours or more, or 4 days or more, or 5 days or more, or 6 days or more, or 1 week or more, or 2 weeks or more, or 3 weeks or more, or 4 weeks or more, or 2 months or more, or 3 months or more, or 4 months or more, or 5 months or more, or 6 months or more, or 9 months or more, or 1 year or more. Examples of stabilizers include, but are not limited to, bovine serum albumin (BSA), sodium azide, glycerol, phenylmethanesulfonyl fluoride (PMSF), and the like. Additional additives may also be present in the composition, such as, additives that preserve cells present in whole blood, e.g., platelet stabilizing factor, and the like. Examples of additives that may be included in the composition are anticoagulants such as ethylenediaminetetraacetic acid (EDTA), buffered citrate, heparin, and the like. The composition may include these additives in a liquid or dried state.

In some instances, the dye component of a given dried dye composition is a conjugate of a dye moiety and a specific binding member. The specific binding member and the dye moiety can be conjugated (e.g., covalently linked) to each other at any convenient locations of the two molecules, via an optional linker.

As used herein, the term “specific binding member” refers to one member of a pair of molecules which have binding specificity for one another. One member of the pair of molecules may have an area on its surface, or a cavity, which specifically binds to an area on the surface of, or a cavity in, the other member of the pair of molecules. Thus, the members of the pair have the property of binding specifically to each other to produce a binding complex. In some embodiments, the affinity between specific binding members in a binding complex is characterized by a K_{d} (dissociation constant) of 10⁻⁸ M or less, such as 10⁻⁷ M or less, including 10⁻⁸ M or less, e.g., 10⁻⁹ M or less, 10⁻¹⁹ M or less, 10⁻¹¹ M or less, 10⁻¹² M or less, 10⁻¹³ M or less, 10⁻¹⁴ M or less, including 10⁻¹⁵ M or less. In some embodiments, the specific binding members specifically bind with high avidity. By high avidity is meant that the binding member specifically binds with an apparent affinity characterized by an apparent K_{d} of 10×10⁻⁹ M or less, such as 1×10⁻⁹ M or less, 3×10⁻¹⁰ M or less, 1×10⁻¹⁰ M or less, 3×10⁻¹¹ M or less, 1×10⁻¹¹ M or less, 3×10⁻¹² M or less or 1×10⁻¹² M or less.

The specific binding member can be proteinaceous. As used herein, the term “proteinaceous” refers to a moiety that is composed of amino acid residues. A proteinaceous moiety can be a polypeptide. In certain cases, the proteinaceous specific binding member is an antibody. In certain embodiments, the proteinaceous specific binding member is an antibody fragment, e.g., a binding fragment of an antibody that specific binds to a polymeric dye. As used herein, the terms “antibody” and “antibody molecule” are used interchangeably and refer to a protein consisting of one or more polypeptides substantially encoded by all or part of the recognized immunoglobulin genes. The recognized immunoglobulin genes, for example in humans, include the kappa (k), lambda (I), and heavy chain genetic loci, which together comprise the myriad variable region genes, and the constant region genes mu (u), delta (d), gamma (g), sigma (e), and alpha (a) which encode the IgM, IgD, IgG, IgE, and IgA isotypes respectively. An immunoglobulin light or heavy chain variable region consists of a “framework” region (FR) interrupted by three hypervariable regions, also called “complementarity determining regions” or “CDRs”. The extent of the framework region and CDRs have been precisely defined (see, “Sequences of Proteins of Immunological Interest,” E. Kabat et al., U.S. Department of Health and Human Services, (1991)). The numbering of all antibody amino acid sequences discussed herein conforms to the Kabat system. The sequences of the framework regions of different light or heavy chains are relatively conserved within a species. The framework region of an antibody, that is the combined framework regions of the constituent light and heavy chains, serves to position and align the CDRs. The CDRs are primarily responsible for binding to an epitope of an antigen. The term antibody is meant to include full length antibodies and may refer to a natural antibody from any organism, an engineered antibody, or an antibody generated recombinantly for experimental, therapeutic, or other purposes as further defined below.

Antibody fragments of interest include, but are not limited to, Fab, Fab′, F(ab′)2, Fv, scFv, or other antigen-binding subsequences of antibodies, either produced by the modification of whole antibodies or those synthesized de novo using recombinant DNA technologies. Antibodies may be monoclonal or polyclonal and may have other specific activities on cells (e.g., antagonists, agonists, neutralizing, inhibitory, or stimulatory antibodies). It is understood that the antibodies may have additional conservative amino acid substitutions which have substantially no effect on antigen binding or other antibody functions.

In certain embodiments, the specific binding member is a Fab fragment, a F(ab′)₂ fragment, a scFv, a diabody or a triabody. In certain embodiments, the specific binding member is an antibody. In some cases, the specific binding member is a murine antibody or binding fragment thereof. In certain instances, the specific binding member is a recombinant antibody or binding fragment thereof.

In certain embodiments, the container also includes a calibration standard. The calibration standard may be useful for determining the accuracy of the assay and for ensuring consistency between subsequent assays. In some cases, the calibration standard includes a labelled bead, such as a fluorescently labelled bead. The fluorescently labelled bead may be a standard fluorescently labeled bead that is typically used as a calibration standard. Examples of standard fluorescently labeled beads include, but are not limited to, fluorescently labelled microparticles or nanoparticles. In some cases, the fluorescently labeled beads are configured such that they remain suspended in the assay mixture and do not substantially settle or aggregate. In some embodiments, the fluorescently labeled beads include, but are not limited to, fluorescently labelled polystyrene beads, fluorescein beads, rhodamine beads, and other beads tagged with a fluorescent dye. Additional examples of fluorescently labeled beads are described in U.S. Pat. Nos. 6,350,619; 7,738,094; and 8,248,597, the disclosures of each of which are herein incorporated by reference in their entirety.

In some cases, the containers facilitate storage of the dye composition for an extended period of time. For instance, a container may be a storage stable container. In some cases, the dye compositions contained in the container are storage stable dye compositions, where the dye compositions are substantially stable for an extended period of time. By “stable” or “storage stable” or “substantially stable” is meant a dye composition that does not significantly degrade and/or lose activity over an extended period of time. For example, a storage stable dye composition may not have significant loss of fluorescence activity due to degradation of the dye composition over an extended period of time, such as 10% or less loss of fluorescence activity, or 9% or less, or 8% or less, or 7% or less, or 6% or less, or 5% or less, or 4% or less, or 3% or less, or 2% or less, or 1% or less loss of fluorescence activity over an extended period of time. In certain instances, a storage stable dye composition has 5% or less loss of fluorescence activity over an extended period of time. In some cases, a storage stable dye composition substantially retains its fluorescence activity over an extended period of time, such as retains 100% of its activity, or 99% or more, or 98% or more, or 97% or more, or 96% or more, or 95% or more, or 94% or more, or 93% or more, or 92% or more, or 91% or more, or 90% or more, or 85% or more, or 80% or more, or 75% or more of its activity over an extended period of time. For example, a storage stable dye composition may retain 90% or more of its fluorescence activity over an extended period of time. In some cases, a storage stable composition retains 95% or more of its fluorescence activity over an extended period of time. An extended period of time is a period of time such as 1 week or more, or 2 weeks or more, or 3 weeks or more, or 1 month or more, or 2 months or more, or 3 months or more, or 4 months or more, or 6 months or more, or 9 months or more, or 1 year or more, or 1.5 years (e.g., 18 months) or more, or 2 years or more, or 2.5 years (e.g., 30 months) or more, or 3 years or more, or 3.5 years (e.g., 42 months) or more, or 4 years or more, or 4.5 years (e.g., 54 months) or more, or 5 years or more. For instance, an extended period of time may be 6 months or more. In some cases, an extended period of time is 9 months or more. In some cases, an extended period of time is 1 year (e.g., 12 months) or more. In some cases, an extended period of time is 1.5 years (e.g., 18 months) or more. In some cases, an extended period of time is 2 years (e.g., 24 months) or more. In some instances, the extended period of time is 10 years or less, such as 7.5 years or less, including 5 years or less, e.g., 2 years or less.

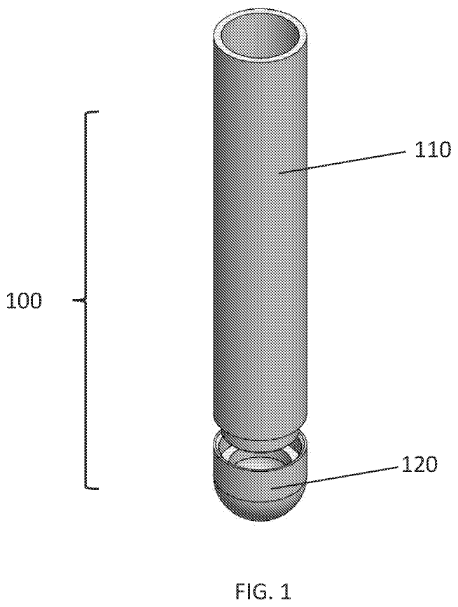

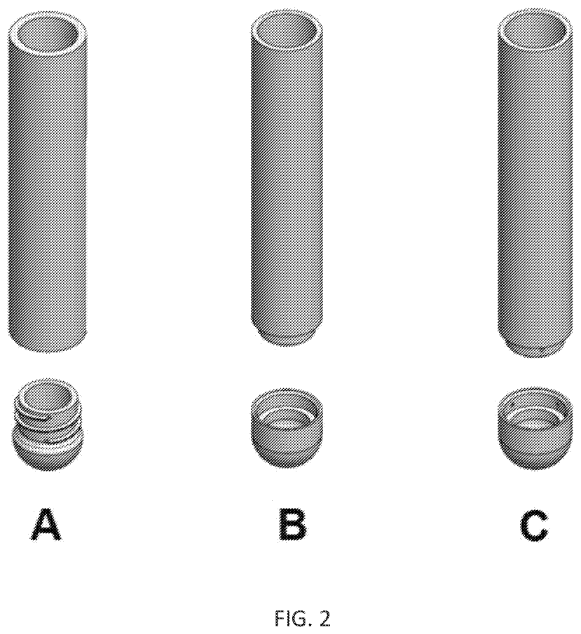

FIG. 1 provides a depiction of a container 100 in accordance with an embodiment of invention. The container 100 depicted in FIG. 1 is made up of two parts, 110 and 120 of a FACS tube that are combined to form a liquid tight round bodied FACS tube 100, where the tube may include a dried high parameter flow cytometry panel made up of a plurality of dried dye compositions distinctly positioned on an inner surface of the tube. The container 100 is made up of a container bottom portion 120 in the form of a truncated FACS tube bottom and a container wall portion 110 in the form of a FACS tube neck. The truncated tube bottom 120 and tube neck 110 can be attached to form the liquid tight round bodied FACS tube 100. FIG. 2 shows models of exemplary ways for combining the tube bottom to the tube neck to form a FACS tube of the invention, e.g., as illustrated in FIG. 1. Panel A provides an illustration of a threaded assembly, Panel B provides and illustration of a press-fit assembly, and Panel C provides an illustration of a snap fit assembly.

### Methods of Making

As summarized above, aspects of the present disclosure include methods of making a reagent comprising container as described herein. The methods may produce a fully assembled container, where separate portions of the container are joined. For example, the methods may produce a container having a container bottom portion attached or joined to a container wall portion, as described above. In such embodiments, the container bottom portion and container wall portion may be configured to attach to each other. The reagent comprising container may include one or more dried reagent compositions positioned on the inner surface of the container bottom portion, as described herein. In certain embodiments, the fully assembled reagent comprising container may be packaged before use in an assay.

In practicing embodiments of the methods of making, aspects of the methods of making may include positioning a first liquid reagent composition on an inner surface of a container bottom portion defining a first volume, drying the first liquid reagent composition to produce a first dried reagent composition, and attaching the container bottom portion to a container wall portion to form a liquid seal attachment region joining the container bottom portion to the container wall portion to produce the reagent comprising container.

As summarized above, aspects of the subject methods may include positioning a liquid reagent composition (e.g., a first liquid reagent composition) on an inner surface of a container bottom portion defining a first volume. In certain embodiments, the liquid reagent composition (e.g., liquid dye composition) is positioned on the surface of the container bottom portion first and then the liquid reagent composition is dried to provide a dried reagent composition on the inner surface of the container bottom portion. The methods may further include positioning two or more liquid reagent compositions on an inner surface of the container bottom portion. In some instances, the container bottom portion is configured in a manner, e.g., has a suitable height, that allows for one or more liquid reagent compositions having a nanoliter volume to be positioned on the inner surface thereof by a liquid handler. In certain embodiments, the method further includes positioning a second liquid reagent composition on an inner surface of the container bottom portion. The method may further include drying the second liquid reagent composition to produce a second dried reagent composition. In some embodiments, a dye composition may be provided as a liquid dye composition and the liquid dye composition may be distinctly positioned on the surface of the container bottom portion. The distinctly positioned liquid dye composition may be dried to provide a distinctly positioned dried dye composition on the inner surface of the container bottom portion. The liquid dye composition may be distinctly positioned on the surface of the container bottom portion using any convenient liquid handling apparatus, such as, but not limited to, syringes, needles, pipets, aspirators, among other liquid handling devices. The liquid handling apparatus may be configured to deposit a nanoliter volume of each of the liquid reagent compositions (e.g., first and second liquid reagent compositions). In certain embodiments, the positioning of the reagent compositions includes depositing the liquid reagent compositions (e.g., first and second liquid reagent compositions) from a liquid handler device. Liquid handler devices of interest include, but are not limited to, commercially available vacuum-based Mantis® nanoliter dispensing technology, and the like. In some instances, the liquid reagent composition may be distinctly positioned on the surface of the container bottom portion using a printer, such as, but not limited to, an inkjet printer.

A liquid reagent composition that is distinctly positioned on the surface of the container bottom portion may be dried using any convenient drying protocol. The liquid reagent composition may be dried before or after the container bottom portion is attached to a container wall portion. In some cases, the drying includes air drying or allowing the liquid reagent composition to dry at room temperature. The air drying may be performed at a temperature ranging, e.g., from 20° C. to 22° C. In some cases, the container bottom portion may be heated or placed in an environment at a temperature greater than standard conditions. In certain instances, the temperature is a temperature greater than standard conditions that is sufficient to dry the liquid reagent composition, e.g., liquid dye composition, but less than a temperature that would cause degradation to the reagent composition. For example, the container bottom portion may be heated to a temperature ranging from 30° C. to 50° C., such as 30° C. to 45° C. to provide a dried dye composition. In certain embodiments, the temperature is applied to the container bottom portion for a time sufficient to dry the dye composition, such as 1 min or more, or 5 min or more, or 10 min or more, or 15 min or more, or 20 min or more, or 30 min or more. In embodiments that include two or more reagent compositions, e.g., dye compositions, on the surface of the container bottom portion, the different reagent compositions may be positioned and dried on the surface of the container bottom portion sequentially, or each reagent composition may be positioned on the surface of the container bottom portion and all of the reagent compositions may be dried simultaneously. In certain embodiments, the liquid reagent compositions are dried by lyophilization.

The volume of liquid reagent compositions (e.g., first and second liquid reagent compositions) positioned in the container bottom portion may vary. In some instances, the liquid reagent compositions have the same volume. In some instances, the liquid reagent compositions have a different volume from one another. In some instances, the volume may range from 1 nl to 1000 ul including, e.g., 1 nl to 900 ul, 1 nl to 800 ul, 1 nl to 700 ul, 1 nl to 600 ul, 1 nl to 500 ul, 1 nl to 400 ul, 1 nl to 300 ul, 1 nl to 200 ul, 1 nl to 100 ul, 10 nl to 900 ul, 10 nl to 800 ul, 10 nl to 700 ul, 10 nl to 600 ul, 10 nl to 500 ul, 10 nl to 400 ul, 10 nl to 300 ul, 10 nl to 200 ul, or 10 nl to 100 ul. In some instances, the volume of each of the liquid reagent compositions positioned in the container bottom portion is a nanoliter volume. The nanoliter volume may range from 1 nl to 1000 nl including, e.g., 1 nl to 900 nl, 1 nl to 800 nl, 1 nl to 700 nl, 1 nl to 600 nl, 1 nl to 500 nl, 1 nl to 400 nl, 1 nl to 300 nl, 1 nl to 200 nl, 1 nl to 100 nl, 10 nl to 900 nl, 10 nl to 800 nl, 10 nl to 700 nl, 10 nl to 600 nl, 10 nl to 500 nl, 10 nl to 400 nl, 10 nl to 300 nl, 10 nl to 200 nl, or 10 nl to 100 nl.

As described herein, the container may include two or more reagent compositions (e.g., dye compositions) distinctly positioned on a surface of a container bottom portion. As such, in some cases, the method includes positioning the liquid reagent compositions at separate locations on the inner surface of the container bottom portion. In some instances, the method further includes positioning a second liquid reagent composition on the inner surface of the container bottom portion at a separate location from the first liquid reagent composition. For example, the method may include positioning first and second polymeric dye compositions at separate locations on the surface of the container bottom portion. Additional liquid reagent compositions (e.g., dye compositions) may be provided on the surface of the container bottom portion, such as a third polymeric dye composition. In these embodiments, the method may further include distinctly positioning the third liquid reagent composition, e.g., polymeric dye composition, on the surface of the container bottom portion. Additional liquid reagent compositions, e.g., polymeric and/or non-polymeric dye compositions, may also be distinctly positioned on the surface of the container bottom portion.

In certain embodiments, the container includes two or more reagent compositions (e.g., dye compositions) co-located at the same location of the surface of the container bottom portion. Accordingly, in these embodiments the method may include co-locating the liquid reagent compositions at the same location of the surface of the container bottom portion. In some instances, the method further comprises positioning a second liquid reagent composition on the inner surface of the bottom container portion at a location co-located with the first liquid reagent composition. For example, the method may include co-locating first and second dye compositions (e.g., first and second polymeric dye compositions) at the same location of the surface of the container bottom portion. In some cases, the method also includes positioning a non-dye material between the co-located reagent compositions, e.g., dye compositions. For instance, the method may include positioning a non-dye material between the first and second polymeric dye compositions. Additional reagent compositions (e.g., dye compositions) may be co-located at the same location of the surface of the container bottom portion, such as a third polymeric dye composition. In these embodiments, the method may further include distinctly positioning the third liquid reagent composition (e.g., third polymeric dye composition) at the same location of the surface of the container bottom portion. Additional liquid reagent compositions, e.g., polymeric and/or non-polymeric dye compositions, may also be distinctly positioned at the same location of the surface of the container bottom portion.

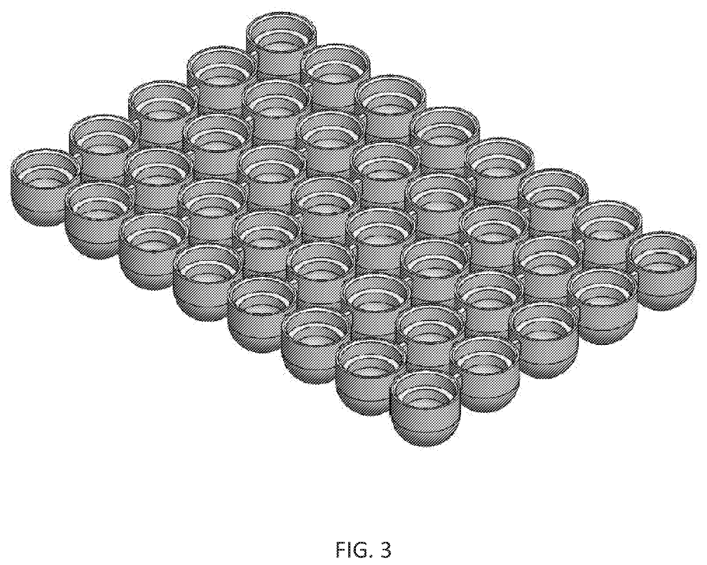

In some instances, the present disclosure provides methods of fabricating containers of the invention using an array of container bottom portions. In such instances, the array of container bottom portions may include a plurality of container bottom portions arranged in rows and columns. The container bottom portions in the array may be connected at the sides to one another. In these cases, the array may include a plurality of container bottom portions, such as 2 or more, or 10 or more, or 50 or more, or 75 or more, or 100 or more, or 300 or more, or 500 or more, or 750 or more, or 1000 or more or 1500 or more, or 2000 or more container bottom portions. One or more of the container bottom portions may be capable of attachment to a container wall portion as described herein. In some instances, each of the container bottom portions may be attached to a container wall portion as described herein. Examples of arrays of container bottom portions may include, for example, 6, 24, 96, 384 or 1536 container bottom portions. In certain embodiments, the array is a multi-well plate and the container bottom portions are wells of a multi-well plate. FIG. 3 shows an exemplary concept for manufacturing container bottom portions, e.g., in the form of short tubes or tube bottoms, in an array of plate wells to allow for more efficient dispensing and drying down of reagents. The shortened tubes, arranged in a manner similar to that of a multi-well plate, allows for multiple reagent dispensing and drying down before the container wall portions, e.g., tube necks, are attached and a cutting instrument is used to separate out the fully assembled containers, e.g., in the form FACS tubes of the invention.

As reviewed above, the method may further include attaching the container bottom portion to a container wall portion to form a liquid seal attachment region joining the container bottom portion to the container wall portion to produce the reagent comprising container. Before attachment, the container wall portion may include an elongated member having open first and second ends separated by a wall. The container bottom portion, e.g., the open end of the container bottom portion, may be attached to the container wall portion at the open first end or the open second end of the container wall portion. The container bottom portion may be attached to the container wall portion by any suitable means. In some instances, the attaching comprises press fitting, snap fitting, or screw threading the bottom container portion and the wall container portion to each other. In some instances, the attaching comprises solvent bonding, adhesive bonding, or welding the bottom container portion and the wall container portion to each other.

As reviewed above, in some instances, the container bottom portion may be one of a plurality of container bottom portions in an array. In such embodiments, the method may include positioning one or more liquid reagent compositions in one or more of the container bottom portions in the array. The method may further include drying the liquid reagent compositions in one or more of the container bottom portions according to any of the drying methods described herein. In some cases, each of the container bottom portions in the array may be individually attached to a container wall portion. In some instances, one of the container bottom portions in the array is attached to a container wall portion to form a container and the container is separated, e.g., detached, from the array of container bottom portions. In such embodiments, the container bottom portion that is attached to the array may be separated from the array.

After joining the container bottom portion with the container wall portion to form the container, the method may further include sealing the container. For example, the method may include applying a seal to the liquid container. As described above, the seal may be a water-tight and/or an air-tight seal. In some instances, the seal is a removable or a breakable seal, which allows a user to subsequently gain access to the contents of the liquid container.

As described above, the container may also include a calibration standard, such as standard fluorescently labelled beads. In these embodiments, the method may further include positioning a set of standard fluorescently labelled beads on the surface of the container (e.g., the inner surface of the container bottom portion). The positioning may be performed using any convenient technique for handling beads. For example, the beads may be provided in a liquid, such as a suspension of beads in a liquid. In these instances, the liquid containing the beads may be positioned on the surface of the container using any convenient liquid handling apparatus, such as, but not limited to, syringes, needles, pipets, aspirators, among other liquid handling devices. In some instances, the liquid containing the beads may be positioned on the surface of the container using a printer, such as, but not limited to, an inkjet printer.

### Methods of Use

As summarized above, aspects of the present disclosure also include methods of using the subject container or reagent comprising container. As described above, the container may include one or more dried reagent compositions (e.g., first and second polymeric dye compositions) distinctly positioned on a surface of the container (e.g., the inner surface of the container bottom portion). As such, the method of using the reagent comprising container may include reconstituting the dried reagent composition(s). In some instances, the dried reagent compositions are dye compositions, e.g., polymeric dye compositions. The polymeric dye compositions may be dried polymeric dye compositions. As such, the method of using the container may include reconstituting the dye composition. In certain embodiments, the method includes combining a volume of a liquid and the container in a manner sufficient to produce a reconstituted composition, e.g., a reconstituted dye composition. The volume of liquid may be added to the container using any convenient liquid handling apparatus, such as, but not limited to, syringes, needles, pipets, aspirators, among other liquid handling devices.

In practicing embodiments of the subject methods, the methods may include introducing a volume of a liquid and into a reagent comprising container, the container comprising: a container bottom portion defining a first volume and comprising a first dried reagent composition positioned on an inner surface thereof, and a container wall portion attached to the container bottom portion at a liquid seal attachment region joining the container bottom portion to the container wall portion, to produce a reconstituted composition.

In some cases, as described above, the container is configured as a liquid container, and as such includes an inner surface and an outer surface. As described above, the inner surface of the liquid container (e.g., the container bottom portion) may include one or more dried reagent compositions (e.g., dried polymeric dye compositions). In these cases, the combining step of the method may include positioning the volume of liquid inside the container. By positioning the volume of liquid inside the container, the liquid may contact the dried reagent compositions (e.g., polymeric dye compositions) on the inner surface of the liquid container. In some cases, the liquid (e.g., water) may be absorbed by the dried reagent compositions (e.g., dried polymeric dye compositions), thus reconstituting the dried polymeric dye compositions.

In certain embodiments, the liquid includes a biological sample. In some cases, the biological sample may be derived from specific biological fluids, such as, but not limited to, blood, mucus, lymphatic fluid, synovial fluid, cerebrospinal fluid, saliva, bronchoalveolar lavage, amniotic fluid, amniotic cord blood, urine, vaginal fluid and semen. In some embodiments, the biological sample includes whole blood or a fraction thereof. In some embodiments, the biological sample includes blood plasma.

In certain embodiments, the container is a sealed container, such as where the container includes a seal (e.g., a water-tight and/or air-tight seal). In these instances, the method may include removing the seal prior to positioning or introducing the volume of liquid inside the liquid container. Removing the seal on the container may expose the contents of the liquid container to the surrounding environment and allow access to the interior volume of the liquid container. Thus, a user that has access to the interior volume of the liquid container may position the volume of liquid inside the liquid container for reconstitution of the dried polymeric dye compositions inside the liquid container.

In certain embodiments, the method also includes mixing the contents of the liquid container after positioning the volume of liquid inside the liquid container. The mixing may be performed using any convenient protocol. For example, the mixing may be performed using an agitator. The agitator may be any convenient agitator sufficient for mixing the liquid inside the liquid container, including, but not limited to, vortexers, sonicators, shakers (e.g., manual, mechanical, or electrically powered shakers), rockers, oscillating plates, magnetic stirrers, static mixers, rotators, blenders, mixers, tumblers, orbital shakers, among other agitating protocols.

In some cases, the method also includes assaying the reconstituted composition, e.g., reconstituted dye composition. Assaying the reconstituted composition, e.g., reconstituted dye composition, may be performed using any suitable assay apparatus. For example, the assay apparatus may be a flow cytometer. In these embodiments, the assaying includes flow cytometrically analyzing the reconstituted composition, e.g., reconstituted dye composition. In some instances, the assaying includes contacting the reconstituted composition, e.g., reconstituted dye composition, with electromagnetic radiation (e.g., light), such as electromagnetic radiation having a wavelength that corresponds to the excitation maxima of the reconstituted composition, e.g., reconstituted dye composition. The assaying may further include detecting emitted light from the excited reagent compositions, e.g., dye compositions. For instance, the method may include detecting emitted light from the excited reagent compositions, e.g., dye compositions, at one or more wavelengths that correspond to the emission maxima of the reagent compositions, e.g., dye compositions.

Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ II flow cytometer, BD Accuri™ flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer BD Biosciences LSRFortessa™ flow cytometer, BD Biosciences LSRFortess™ X-20 flow cytometer and BD Biosciences FACSCalibur™ cell sorter, a BD Biosciences FACSCountTM cell sorter, BD Biosciences FACSLyric™ cell sorter and BD Biosciences Via™ cell sorter BD Biosciences Influx™ cell sorter, BD Biosciences Jazz™ cell sorter, BD Biosciences Aria™ cell sorters and BD Biosciences FACSMelody™ cell sorter, or the like.

In certain embodiments, the subject flow cytometric systems are configured to sort one or more of the particles (e.g., cells) of the sample. The term “sorting” is used herein in its conventional sense to refer to separating components (e.g., cells, non-cellular particles such as biological macromolecules) of the sample and in some instances delivering the separated components to one or more sample collection containers. For example, the subject systems may be configured for sorting samples having 2 or more components, such as 3 or more components, such as 4 or more components, such as 5 or more components, such as 10 or more components, such as 15 or more components and including soring a sample having 25 or more components. One or more of the sample components may be separated from the sample and delivered to a sample collection container, such as 2 or more sample components, such as 3 or more sample components, such as 4 or more sample components, such as 5 or more sample components, such as 10 or more sample components and including 15 or more sample components may be separated from the sample and delivered to a sample collection container.

In some embodiments, particle sorting systems of interest are configured to sort particles with an enclosed particle sorting module, such as those described in U.S. Patent Publication No. 2017/0299493, filed on Mar. 28, 2017, the disclosure of which is incorporated herein by reference. In certain embodiments, particles (e.g., cells) of the sample are sorted using a sort decision module having a plurality of sort decision units, such as those described in U.S. patent application Ser. No. 16/725,756, filed on Dec. 23, 2019, the disclosure of which is incorporated herein by reference.

In some embodiments, the flow cytometer systems are flow cytometric systems, such those described in U.S. Pat. No. 10,006,852; 9,952,076; 9,933,341; 9,784,661; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; the disclosure of which are herein incorporated by reference in their entirety.

Other methods of analysis may also be used, such as, but not limited to, liquid chromatography-mass spectrometry or gas chromatography-mass spectrometry systems. For example, assaying may include the use of an analytical separation device such as a liquid chromatograph (LC), including a high performance liquid chromatograph (HPLC), a micro- or nano-liquid chromatograph or an ultra-high pressure liquid chromatograph (UHPLC) device, a capillary electrophoresis (CE), or a capillary electrophoresis chromatograph (CEC) apparatus. Mass spectrometer (MS) systems may also be used to assay the reagent compositions, e.g., dye compositions. Examples of mass spectrometers may include, but are not limited, to electrospray ionization (ESI), atmospheric pressure chemical ionization (APCI), electron impact (El), atmospheric pressure photoionization (APPI), matrix-assisted laser desorption ionization (MALDI) or inductively coupled plasma (ICP) ionization, for example, or any combination thereof. Likewise, any of a variety of different mass analyzers may be employed, including time of flight (TOF), Fourier transform ion cyclotron resonance (FTICR), ion trap, quadrupole or double focusing magnetic electric sector mass analyzers, or any hybrid thereof.

In certain embodiments, the container is included in an apparatus that is fully automated. By “fully automated” is meant that the apparatus receives a container and prepares a reconstituted composition, e.g., reconstituted dye composition, with little to no human intervention or manual input into the subject systems. In certain embodiments, the subject systems are configured to prepare and analyze the reconstituted composition, e.g., reconstituted dye composition, without any human intervention.

In certain embodiments, the method also includes storing the reconstituted composition, e.g., reconstituted dye composition, for a period of time. The reconstituted composition, e.g., reconstituted dye composition, may be stored for a period of time before, during and/or after assaying the reconstituted composition, e.g., reconstituted dye composition. In some instances, the reconstituted composition, e.g., reconstituted dye composition, is stored for a period of time such as 24 hours or more, or 48 hours or more, or 72 hours or more, or 4 days or more, or 5 days or more, or 6 days or more, or 1 week or more, or 2 weeks or more, or 3 weeks or more, or 4 weeks or more, or 2 months or more, or 3 months or more, or 4 months or more, or 5 months or more, or 6 months or more, or 9 months or more, or 1 year or more. In certain cases, the reconstituted composition is stored for 24 hours or more. In certain cases, the reconstituted composition is stored for 48 hours or more. In certain cases, the reconstituted composition is stored for 72 hours or more. In certain cases, the reconstituted composition is stored for 1 week or more. In certain cases, the reconstituted composition is stored for 2 weeks or more. In certain cases, the reconstituted composition is stored for 3 weeks or more.

Embodiments of the method may further include shipping the reconstituted composition to a remote location. A “remote location,” is a location other than the location at which the dye composition is reconstituted. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or one hundred miles or more apart.

### Utility

The subject containers and methods find use in applications where cell analysis from a biological sample may be desired for research, laboratory testing or for use in therapy. In some embodiments, the subject containers and methods facilitate analysis of cells obtained from fluidic or tissue samples such as specimens for diseases, including but not limited to cancer. Containers and methods of the present disclosure also allow for analyzing cells from a biological sample (e.g., organ, tissue, tissue fragment, fluid) with enhanced efficiency and low cost.

The subject containers and methods find use in applications where the analysis of a sample using two or more reagents (e.g., dye compositions) is desired. For example, the subject containers and methods find use in applications where the analysis of a sample using two or more polymeric dye compositions is desired. Embodiments of the subject containers and methods also find use in applications where analysis of a sample using two or more polymeric dye compositions in combination with one or more non-polymeric dye compositions is desired. Thus, the subject containers and methods find use in applications where a sample is analyzed for two or more analytes of interest using two or more corresponding polymeric dye compositions. In some cases, where non-polymeric dye compositions are also included in the containers, the subject containers and methods find use in applications where a sample is analyzed for two or more analytes of interest using two or more corresponding polymeric dye compositions and non-polymeric dye compositions.

The subject containers and methods find use in applications where a minimization in dye-dye interactions is desired. As described herein, embodiments of the subject containers and methods provide two or more dried polymeric dye compositions that are distinctly positioned on an inner surface of the container bottom portion. As such, the distinct positioning of the dye compositions relative to each other on the surface of the container bottom portion facilitates a minimization in dye-dye interactions. A minimization in dye-dye interactions may facilitate the collection of more precise and/or accurate data with respect to the assays performed using the subject containers. For instance, the subject containers and methods may facilitate a reduction in dye-dye interactions as compared to containers in which two or more dye compositions are provided but are not distinctly positioned relative to each other.

### Kits

Aspects of the present disclosure also include kits. The kits may include, e.g., a reagent comprising container according to any of the embodiments described herein. Aspects of the reagent comprising container may include a container bottom portion defining a first volume and comprising a first dried reagent composition positioned on an inner surface thereof, and a container wall portion attached to the container bottom portion at a liquid seal attachment region joining the container bottom portion to the container wall portion.

In certain embodiments, the kit includes a subject container and a packaging configured to hold the container. The packaging may be a sealed packaging, e.g., a water vapor-resistant container, optionally under an air-tight and/or vacuum seal. In certain instances, the packaging is a sterile packaging, configured to maintain the device enclosed in the packaging in a sterile environment. By “sterile” is meant that there are substantially no microbes (such as fungi, bacteria, viruses, spore forms, etc.). The kits may further include a buffer. For instance, the kit may include a buffer, such as a sample buffer, a wash buffer, an assay buffer, and the like. The kits may further include additional reagents, such as but not limited to, detectable labels (e.g., fluorescent labels, colorimetric labels, chemiluminescent labels, multicolor reagents, avidin-streptavidin associated detection reagents, radiolabels, gold particles, magnetic labels, etc.), and the like. In certain embodiments, the kits may also include a calibration standard. For example, the kits may include a set of labelled beads, such as a set of standard fluorescently labelled beads.

In addition to the above components, the subject kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Another means would be a computer readable medium, e.g., CD, DVD, Blu-Ray, computer-readable memory (e.g., flash memory), etc., on which the information has been recorded or stored. Yet another form that may be present is a website address which may be used via the Internet to access the information at a removed site. Any convenient form of instructions may be present in the kits.

The following examples are offered by way of illustration and not by way of limitation.

### EXPERIMENTAL

A large proportion of liquid handlers use a flying droplet dispense protocol to dispense reagents. Due to droplet drift, the positional accuracy of such a dispense protocol is highly dependent on the dispense height (distance between dispensing nozzle and target surface). The overall height of even the smallest volume FACS tube used for sample analysis makes it very difficult to control the positional accuracy of the dispense to within a reasonable tolerance. This positional accuracy is needed to achieve multiple dispenses of wet reagents, while maintaining reagent separation and preventing dye-to-dye interactions of BD's Horizon Sirigen dye portfolio. For example, when dispensing wet reagents with volumes of less than 500 nl into a 5 ml round-bottomed tube, the droplet is likely to make contact with the side of the tube before reaching the tube bottom, and if it does reach the tube bottom, it is almost impossible to ensure it will not touch a previously dispensed wet reagent, causing dye-to-dye interactions.

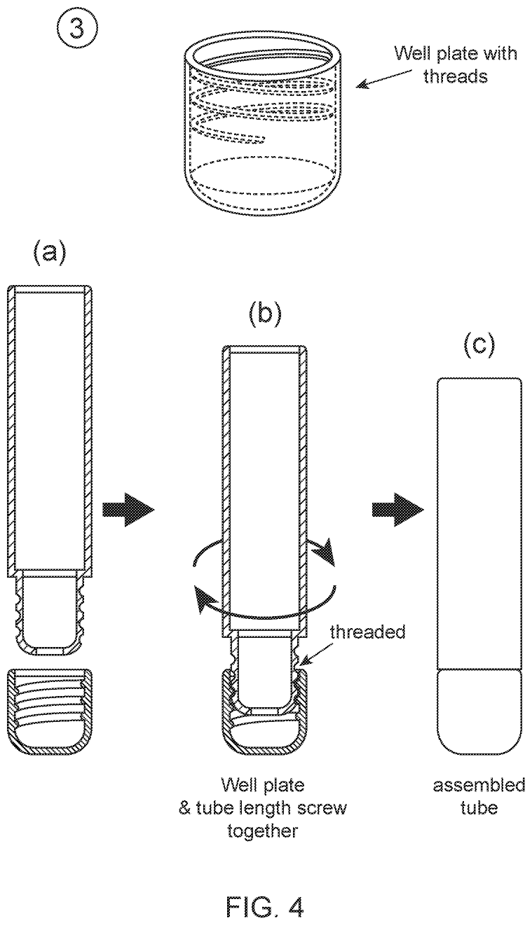

FIG. 4 shows an embodiment of a method of dispensing reagents into a shortened tube or tube bottom before assembling a FACS tube. The method includes (a) dispensing into a container bottom portion, e.g., in the form of a shortened FACS tube, to reduce the issue of dispense height affecting droplet placement accuracy, and then drying down the dispensed reagents before (b) attaching the container wall portion, e.g., in the form of a tube neck, to produce a complete container of an embodiment of the invention, e.g., the form of a full FACS tube. The method and design of the 2-part FACS tube as illustrated in FIG. 4 allows for a flying droplet to be accurately dispensed in the nanoliter range to a precise, predetermined location the bottom of the FACS tube.

The method may leverage commercially available vacuum-based Mantis® nanoliter dispensing technology to dispense spatially separated polymeric dyes, such as BD Horizon™ Sirigen reagents, e.g., as described above, into a short round-bottomed tube. Dispensing into a shortened tube and building the full tube after the liquid reagents have been dried provides an opportunity to increase the spatial accuracy of the dispense. With the short tube and tube assembly technique, many different liquid handlers capable of dispensing volumes accurately in the nanoliter range may be used. The liquid tight tubes with separated dried down reagent panels can be incubated with patient samples and run on a flow cytometer.

Reducing the dispense height lowers the risk of droplet drift causing spatial inaccuracies in a flying droplet dispense system. As the dispense length is less than 5 mm, it is possible to dispense multiple reagents and keep them spatially separated in the short tube. With the nanoliter spotting capability of the Mantis®, this opens the opportunity to produce a high parameter panel, consisting of multiple spatially separated reagents including, e.g., BD Horizon™ Sirigen dyes and non-polymeric dyes. With increased dispensing accuracy at nanoliter range, there is a greater surface area in the bottom tube to build more complex panels. Using the two-part FACS tube with vacuum based dispensing methods, in some instances ten or more BD Horizon™ Sirigen dyes may be individually dispensed into the bottom well of a tube in addition to a 9-colour reagent cocktail with non-polymeric dyes. With nanoliter dispensing, the 8 non-polymeric dyes & 1 BD Horizon™ Sirigen dye can be dispensed in the center of the tube well with up to ten BD Horizon™ Sirigen dyes spotted around it. Tube geometry calculations of the tube bottom factors in space for droplet drift during dispensing or drying to predict a potential to dispense up to 19 reagents in one tube.

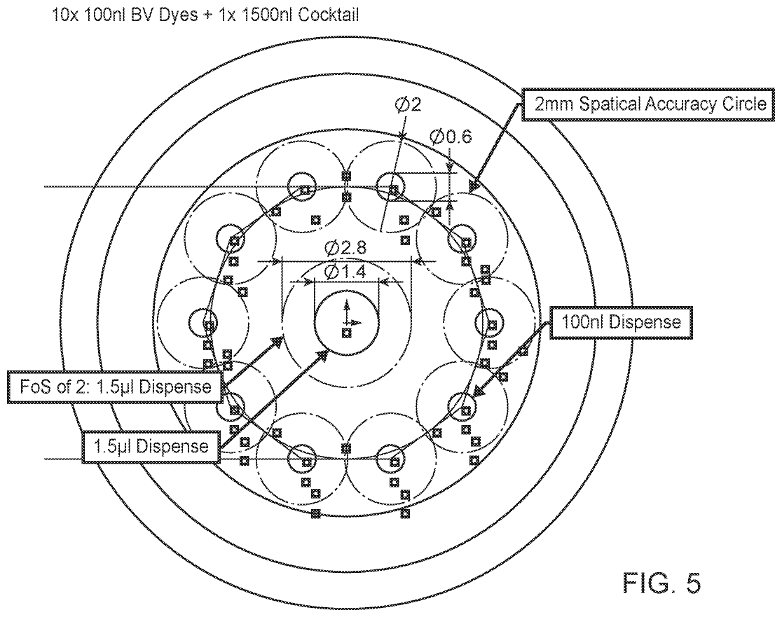

FIG. 5 provides calculations to demonstrate how many 100 nl reagent dispenses could fit in a 5 ml FACS tube (e.g., how many 100 nl BD Horizon™ Sirigen dyes would fit around a larger cocktail dispense in the 5 ml FACS tube).

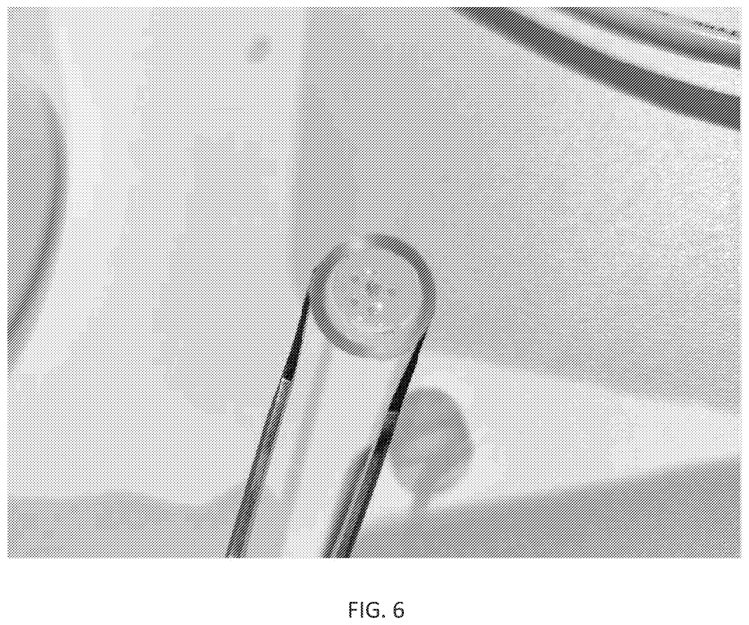

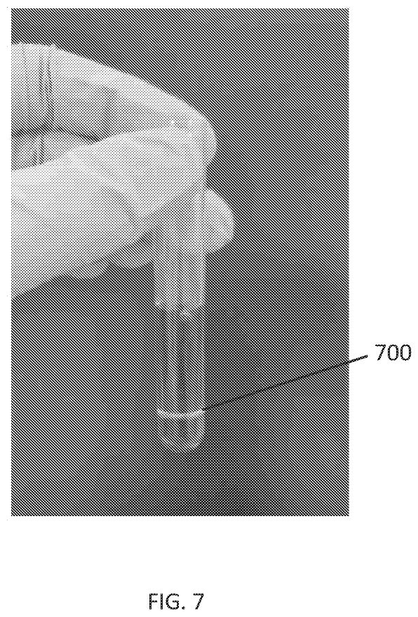

FIG. 6 illustrates spatially separated liquid dispenses in a truncated tube. FIG. 7 shows a fully assembled FACS tube with a connection line 700 indicating the interface of the tube bottom and tube neck.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A reagent comprising container comprising:
a container bottom portion defining a first volume and comprising a first dried reagent composition positioned on an inner surface thereof, and
a container wall portion attached to the container bottom portion at an attachment region joining the container bottom portion to the container wall portion.

2. The reagent comprising container of claim 1, wherein the container bottom portion is irreversibly attached to the container wall portion.

3. The reagent comprising container of claim 1, wherein the container bottom portion comprises a closed end and a wall rising therefrom.

4. The reagent comprising container of claim 1, wherein the container wall portion comprises an elongated member having a wall and an open first end.

5. The reagent comprising container of claim 1, wherein the container wall portion and the container bottom portion are press fitted, snap fitted, or screwed together.

6. The reagent comprising container of claim 1, wherein the container wall portion and the container bottom portion are solvent bonded, adhesive bonded, or welded to each other.

7. (canceled)

8. The reagent comprising container of claim 1, wherein the container bottom portion comprises a second dried reagent composition positioned on the inner surface thereof.

9. The reagent comprising container of claim 8, wherein the first and second dried reagent compositions comprise a dye.

10. The reagent comprising container of claim 9, wherein the dye is a polymeric dye.

11. The reagent comprising container of claim 10, wherein the polymeric dye is a water-soluble conjugated polymer.

12. (canceled)

13. The reagent comprising container of claim 9, wherein the dye is a conjugate of a dye moiety and a specific binding member.

14. (canceled)

15. The reagent comprising container of claim 8, wherein the first and second dried reagent compositions are adhered to the inner surface of the container bottom portion.

16.-19. (canceled)

20. The reagent comprising container of claim 8, wherein the first or second dried reagent composition comprises two or more dyes.

21.-25. (canceled)

26. The reagent comprising container of claim 1, wherein the container bottom portion comprises three or more, four or more, five or more, six or more, ten or more, fifteen or more, or nineteen or more dried reagent compositions positioned on the inner surface thereof.

27.-32. (canceled)

33. The reagent comprising container of claim 1, wherein the container is a tube or vial.

34.-80. (canceled)

81. A method comprising:
introducing a volume of a liquid and into a reagent comprising container, the container comprising:
a container bottom portion defining a first volume and comprising a first dried reagent composition positioned on an inner surface thereof, and
a container wall portion attached to the container bottom portion at a sealed attachment region joining the container bottom portion to the container wall portion,
to produce a reconstituted composition.

82. The method of claim 81, wherein the liquid comprises a biological sample.

83.-124. (canceled)

124. A kit comprising:
a reagent comprising container comprising:
a container bottom portion defining a first volume and comprising a first dried reagent composition positioned on an inner surface thereof, and
a container wall portion attached to the container bottom portion at a sealed attachment region joining the container bottom portion to the container wall portion.

125.-128. (canceled)

129. The kit of claim 124, wherein the container wall portion and the container bottom portion are permanently attached to each other.

130. (canceled)

131. The kit of claim 124, wherein the container bottom portion comprises a second dried reagent composition positioned on the inner surface thereof.

132.-159. (canceled)
